(19) United States
(12) Patent Application Publication
(10) Pub. No.: US 2026/0291391 A1
(43) Pub. Date: Sep. 24, 2026

(54) CONTROLLER AND METHOD FOR OPERATING A POWER CONVERTER IN A PLURALITY OF MODES

(71) Applicant: Renesas Design (UK) Limited, Bourne End (GB)

(72) Inventor: Stefan DIETRICH, Germering (DE)

(73) Assignee: Renesas Design (UK) Limited, Bourne End (GB)

(21) Appl. No.: 19/087,393

(22) Filed: Mar. 21, 2025

(51) Int. Cl. H02M 3/158; H02M 1/00

(52) U.S. Cl. CPC H02M 3/1582; H02M 1/0009

(57) ABSTRACT

A method of operating a power converter includes: starting a clock signal having a clock on-time that defines the start of a switching cycle; starting a timer for generating a timer signal having a timer on-time at the beginning of the switching cycle; sensing an inductor current; adding a ramp signal to the sensed inductor current to obtain a compensated inductor current signal; comparing the compensated inductor current signal with an error signal to obtain a comparison signal; determining a position of the comparison signal within the switching cycle by identifying if the comparison signal of the sensed inductor current occurs during or after the timer on-time, or during the clock on-time; wherein adding the ramp signal to the sensed inductor current is based on the position of the comparison signal; and operating the power converter in buck-boost mode, boost mode, or intermediate mode using the comparison signal.

### TECHNICAL FIELD

The present disclosure relates to a method of operating a power converter in a plurality of modes that include a buck-boost mode, a boost mode, and an intermediate mode between the buck-boost mode and the boost mode; the method comprising.

### BACKGROUND

A portable electronic device uses a rechargeable battery as an unregulated energy source for various different electronic load circuits which typically require a stable regulated voltage source. A switching voltage converter is typically used to convert the unregulated battery voltage of the battery to a regulated output voltage for one or more load circuits.

During the operation of the portable device, the battery voltage drops as the battery is discharged. As a result of this, the battery voltage may be above the regulated output voltage, about the same as the output voltage, or below the output voltage. Therefore, the power converter should be able to operate in a buck mode (for providing a regulated output voltage Vout which is smaller than the input voltage Vin), in a buck-boost mode (for providing a regulated output voltage Vout which has a similar level as the input voltage Vin) and in a boost mode (for providing a regulated output voltage Vout which is greater than the input voltage Vin).

The transition between the different operation modes (buck mode, buck-boost mode, boost mode) may lead to overshoots or undershoots of the output voltage.

The present document addresses the technical problem of enabling a power converter for transitioning between different operation modes in a stable manner, notably without incurring overshoots and/or undershoots of the output voltage.

It is an object of the disclosure to address one or more of the above mentioned limitations.

### SUMMARY

According to a first aspect of the disclosure, there is provided a method of operating a power converter in a plurality of modes that include a buck-boost mode, a boost mode, and an intermediate mode between the buck-boost mode and the boost mode; the method comprising:
starting a clock signal having a clock on-time, and wherein the clock on-time defines the start of a given switching cycle;
starting a timer for generating a timer signal at the beginning of the given switching cycle, wherein the timer signal has a timer on-time;
sensing a current through an inductor of the power converter to obtain a sensed inductor current;
adding a ramp signal to the sensed inductor current to obtain a compensated inductor current signal;
comparing the compensated inductor current signal with an error signal to obtain a comparison signal;
determining a position of the comparison signal within the given switching cycle by identifying if the comparison signal of the sensed inductor current occurs during the timer on-time, or after the timer on-time, or during the clock on-time; and
wherein adding the ramp signal to the sensed inductor current is based on the position of the comparison signal; and
operating the power converter in the buck-boost mode, the boost mode, or the intermediate mode using the comparison signal.

For instance, each switching cycle may have a constant period T between two consecutive clock on-time.

For instance, the timer on-time may have a time duration greater than the clock on-time.

For instance, the error signal may be based on an output voltage of the power converter and a reference (or target) voltage.

Optionally, the method further comprising:
when the comparison signal occurs during the timer on-time, adding the ramp signal between the end of the timer signal of the given switching cycle and a peak current event of a subsequent switching cycle directly following the given switching cycle to operate the power converter in the intermediate mode; and
when the comparison signal occurs after the timer on-time, adding the ramp signal between the peak current event of the given switching cycle and the peak current event of the subsequent switching cycle directly following the given switching cycle to operate the power converter in the boost mode; and
when the comparison signal occurs during the clock on-time, adding the ramp signal between the start of the clock signal and a peak current event of the subsequent switching cycle directly following the given switching cycle to operate the power converter in the buck-boost mode.

Optionally, the method further comprising:
when the converter operates in the buck-boost mode,
   determining if the comparison signal occurs before the on-time of a clock signal;
   maintaining operation in the buck-boost mode within a subsequent switching cycle, if the comparison signal triggers before the clock on time; and
   operating the power converter in the intermediate mode within the subsequent switching cycle if the clock on time arrives before the comparison signal triggers.

Optionally, the method further comprising:
when the converter operates in the intermediate mode,
   determining if the comparison signal occurs during or after the clock on-time; and
   maintaining operation in the intermediate mode within a subsequent switching cycle, if the comparison signal occurs after the clock on-time; and
   if the comparison signal occurs during the clock on-time, complete the switching cycle and stop adding the ramp signal to the subsequent switching cycle to operate the power converter in the buck-boost mode.

Optionally, the method further comprising:
when the converter operates in the intermediate mode,
   identifying the state of the comparison signal and of a trigger signal that triggers the end of the timer on time; and
   maintaining operation in the intermediate mode if within a given switching cycle the comparison signal is in a logic high state while the trigger signal is in a logic low state; and
   operating the power converter in boost mode within the subsequent switching cycle if within a given switching cycle the comparison signal and the trigger signal are both in a logic high state at a same time.

Optionally, the method further comprising:
when the converter operates in the boost mode,
   identifying the state of the comparison signal and of a trigger signal that triggers the end of the timer on time; and
   maintaining operation in the boost mode if within a given switching cycle the comparison signal and the trigger signal are both in a logic high state at a same time; and
   operating the power converter in intermediate mode within the subsequent switching cycle if within a given switching cycle the comparison signal is in a logic high state while the trigger signal is in a logic low state.

Optionally, wherein the power converter comprises a first power switch arranged between an input port and a first node of the inductor; a second power switch arranged between the first node of the inductor and ground; a third power switch arranged between a second node of the inductor and ground; and a fourth power switch arranged between an output port and the second node of the inductor.

Optionally, wherein in the intermediate mode and in the boost mode, the power converter is operated in a first phase with the first and third power switches and a second phase with the first and fourth power switches, and wherein the peak current event occurs within the switching cycle at a point in time between the first phase and the second phase.

Optionally, wherein in the buck boost mode, the power converter is operated in a first phase with the first and third power switches, a second phase with the first and fourth power switches, and a third phase with the second and fourth power switches, and wherein the peak current event occurs within the switching cycle at a point in time between the second phase and the third phase.

According to a second aspect of the disclosure, there is provided controller for controlling a power converter, wherein the controller is configured to operate the power converter in a buck-boost mode or an intermediate mode or a boost mode; wherein the controller is configured to perform the method according to the first aspect.

Optionally, the controller comprises a ramp generator for generating the ramp signal; an error amplifier configured to generate the error signal; a comparator having a first input for receiving the error signal and a second input for receiving the compensated inductor current signal; a timer for generating the timer signal; a clock generator for generating the clock signal; a logic circuit configured to generate a control signal to control the ramp generator.

For instance, the ramp generator may be configured to generate a ramp signal having a predefined ramp signal having a predefined slope.

Optionally, wherein the control signal is configured to control a timing of when the ramp signal should be generated during the switching cycle.

Optionally, the logic circuit comprises an OR logic gate having a first input for receiving the comparison signal, a second input for receiving a trigger signal that triggers the end of the timer on time; and a third input for receiving the clock signal.

According to a third aspect of the disclosure, there is provided a power converter comprising a controller according to a second aspect coupled to a power stage provided between an input port and an output port.

Optionally, wherein the power stage comprises: an inductor; a first power switch arranged between the input port and a first node of the inductor; a second power switch arranged between the first node of the inductor and ground; a third power switch arranged between a second node of the inductor and ground; and a fourth power switch arranged between the output port and the second node of the inductor.

### DESCRIPTION OF THE DRAWINGS

The disclosure is described in further detail below by way of example and with reference to the accompanying drawings, in which:

FIG. 1A is a diagram of a buck-boost power converter according to the prior art;

FIG. 1B is a is a plot showing the conventional inductor current waveforms for Buck, Boost and Buck-Boost operation of the power converter of FIG. 1A;

FIG. 2 is a plot illustrating the operation of a power converter with improved Boost mode regulation;

FIG. 3 is a flow chart of a method for operating a power converter in a plurality of modes according to the disclosure;

FIG. 4 is a diagram of a power converter for implementing the method of FIG. 3;

FIG. 5 is a diagram of a power stage for use in the power converter of FIG. 4;

FIG. 6 is a plot illustrating the operation of the power converter of FIG. 4 in the intermediate mode;

FIG. 7 is a plot illustrating transition between Buck-Boost, Hybrid Boost and Boost modes;

FIG. 8 is a plot showing the transition from Bubo to Hybrid Boost mode;

FIG. 9 is a plot showing the transition from Hybrid Boost to Bubo mode;

FIG. 10 is a plot showing the transition from Hybrid Boost to Boost mode;

FIG. 11 is a plot showing the transition from Boost to Hybrid Boost mode;

FIG. 12 is a simulation comparing transition from Buck-Boost mode to Boost mode using the method of FIG. 3 compared with the method described in FIG. 2;

FIG. 13 is a simulation comparing transition from Boost mode to Buck-Boost mode using the method of FIG. 3 compared with the method described in FIG. 2;

FIG. 14 is a simulation comparing transition across all modes using the method of the disclosure compared with the method described in FIG. 2.

### DESCRIPTION

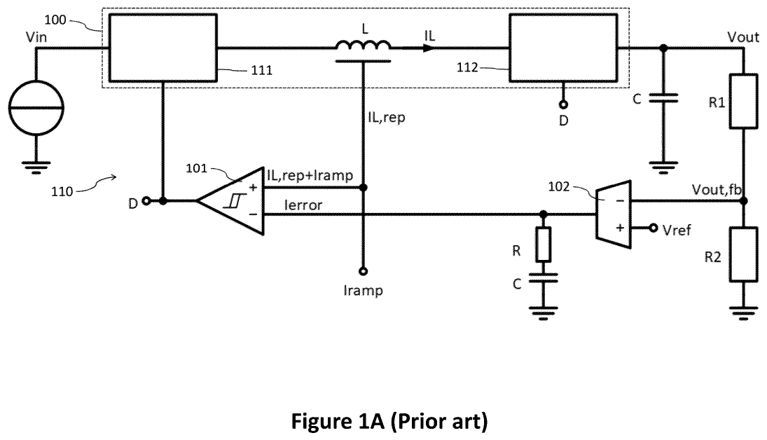

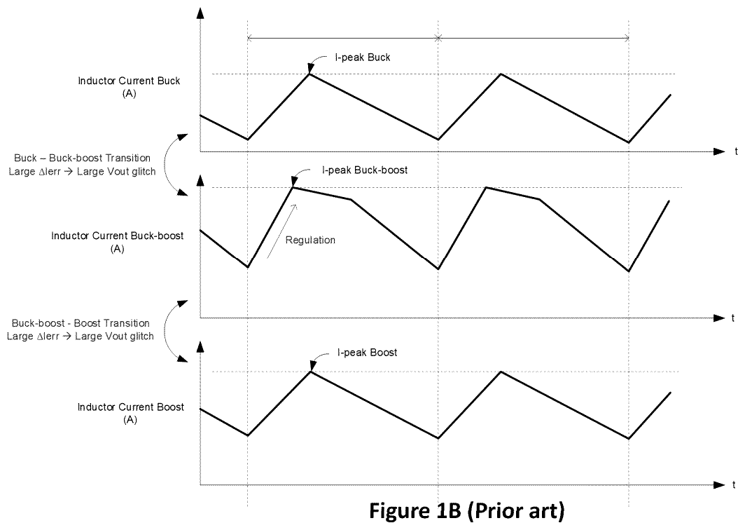

FIG. 1A is a diagram of a buck-boost power converter according to the prior art. The power converter includes an inductor L coupled to an input switch unit 111, and an output switch unit 112. The input switch unit 111 has high-side input power switch and the low-side input power switch. Similarly, the output switch unit 112 has high-side output power switch and the low-side output power switch. A regulation loop includes an error amplifier 102 coupled to a comparator 101. The power converter is operated repeatedly in a sequence of switching cycles. Each switching cycle has a pre-determined cycle duration defined by a clock.

FIG. 1B is a plot showing the conventional inductor current waveforms for Buck, Boost and Buck-Boost operation of the power converter of FIG. 1A. FIG. 1B illustrates the CMC methodology of classic prior art buck-boost converters. All three modes utilize peak current mode control with a fixed operating frequency. The classic prior art CMC of the three operating modes has large ΔIerror at the mode boundaries, resulting in output voltage overshoot or undershoot.

Each of the modes regulate the inductor peak current and start from the same clock period. Depending on each Vin-to-Vout ratio, the modes will have a different duty cycle. The duty cycles at the buck-bubo boundary for a given Vout and Vin=Vout+10% are:

$$M . buck = D = \frac{Vout}{1.1 * Vout} = 0.91 \neq M . bubo = \frac{D}{1 - D} = 0.48$$

The duty cycles at the bubo-boost boundary of prior art for a given Vout and Vin=Vout−10% are:

$$M . bubo = \frac{D}{1 - D} = 0.53 \neq M . boost = \frac{1}{1 - D} = 0.1$$

This difference causes a Vout response if the converter changes modes and the regulation with its finite bandwidth must correct the difference in duty cycle for the new mode.

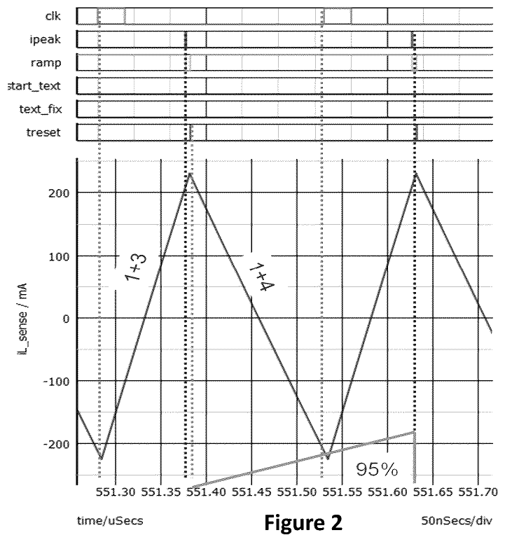

FIG. 2 is a plot illustrating the operation of a power converter with improved Boost mode regulation. Results are presented for Boost mode/VIN=2.8V/VOUT=3.6V/Lout=470 nH/iload=0/force_pwm. In this example a peak-to peak control method is used to provide a smooth transition from a Buck-boost mode to a Boost mode of operation. However, a limitation occurs while operating in the Boost mode while Vin is only slightly less than Vout. At this condition, the ON-time of the Boost mode operation becomes very short time variations due to parasitic and feedback loop delays cause large errors of the ON-Time of the power converter. This creates errors in Vout as well and loop stability issues. Mode transitions from Bubo to Boost mode are unstable due to aliasing.

In order to achieve a seamless mode transition response, the duty cycles should be matched between two adjacent modes at the respective mode boundary. To obtain 95% duty cycle in Boost mode, a current measurement of the respective switching cycle is initiated at the previous trigger of ipeak. This is possible due to the presence and current measurement across the high side input power switch, which is always “on” in Boost mode. In steady state conditions, ipeak to next ipeak yields 100% duty cycle. To restart the regulation loop correctly, ~5% duty cycle is used to reset the previous cycle current information, e.g. restart the ramp, reset the PWM current comparator. Hence, the Boost mode measures between falling 1+4 and rising 1+3 edges, ignoring clk overlap in the regulation. This leads to 95% duty cycle in the loop, even if the inductor charge and on-time is still ~44%. With this method, the regulation never faces issues with minimum on-time, since 95% duty cycle is maintained by measuring at falling+rising edges all the time. In theory, the inductor on-time 1+3 can reach zero (bypass mode) without regulation issues.

However, when operating in peak-to-peak Boost mode when Vin-Vout, the inductor charge time of the converter is very short and is susceptible to timing delays. Even though measuring from peak-to-peak and therefore ~95% duty cycle, the converter may become unstable as soon as the inductor charge time is similar or shorter than the converter loop delay, which is a measure of the converter's delay in adjusting the inductor current in response to a change in the converter's feedback signals, for example Vout, fb of FIG. 1a. There is an aliasing effect visible, with a peak trigger that misses the actual peak.

By adding the ramp shortly after the previous peak, only an artificial ramp to increase the converter duty cycle is then measured, but the true peak current information during the inductor charge phase, included in the artificial ramp, is missed. The converter degrades to a voltage-mode converter without current information, such that the inner current loop collapses, and the converter becomes unstable.

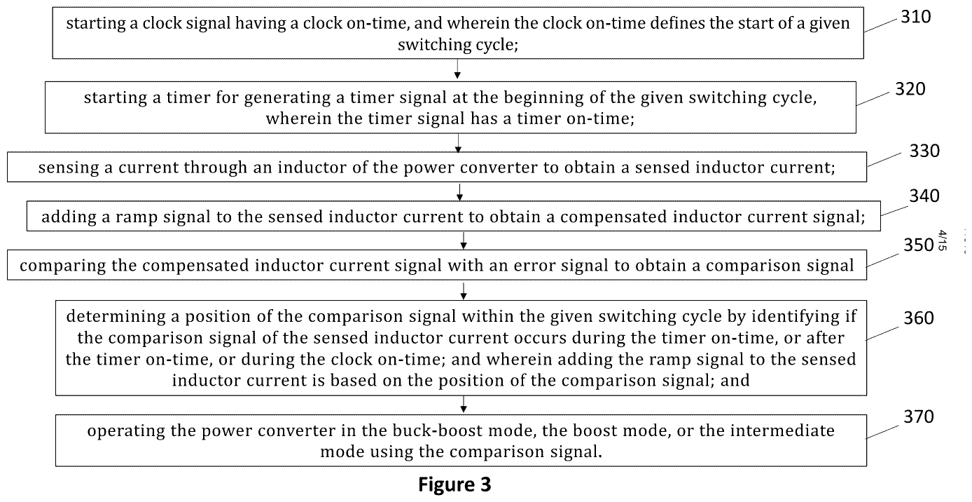

FIG. 3 is a flow chart of a method for operating a power converter in a plurality of modes according to the disclosure. The plurality of modes includes a buck-boost mode, a boost mode, and an intermediate mode between the buck-boost mode and the boost mode.

At step 310, a clock signal having a clock on-time is started. The clock on-time defines the start of a given switching cycle.

At step 320, a timer is started for generating a timer signal at the beginning of the given switching cycle, wherein the timer signal has a timer on-time.

At step 330, a current is sensed through an inductor of the power converter to obtain a sensed inductor current.

At step 340, a ramp signal is added to the sensed inductor current to obtain a compensated inductor current signal.

At step 350, the compensated inductor current signal is compared with an error signal to obtain a comparison signal.

At step 360, a position of the comparison signal within the given switching cycle is determined by identifying if the comparison signal of the sensed inductor current occurs during the timer on-time, or after the timer on-time, or during the clock on-time. The addition of the ramp signal to the sensed inductor current (at step 340) is based on the position of the comparison signal.

At step 370, the power converter is operated in the buck-boost mode, the boost mode, or the intermediate mode using the comparison signal.

By adding an intermediate mode, also referred to as hybrid Boost mode, the method stabilizes the transition between Buck Boost (Bubo) and hybrid Boost and between hybrid Boost and Boost. It also removes duty cycle discontinuities at the two adjacent mode boundaries and achieves automatic seamless mode transitions to its adjacent Bubo and Boost modes.

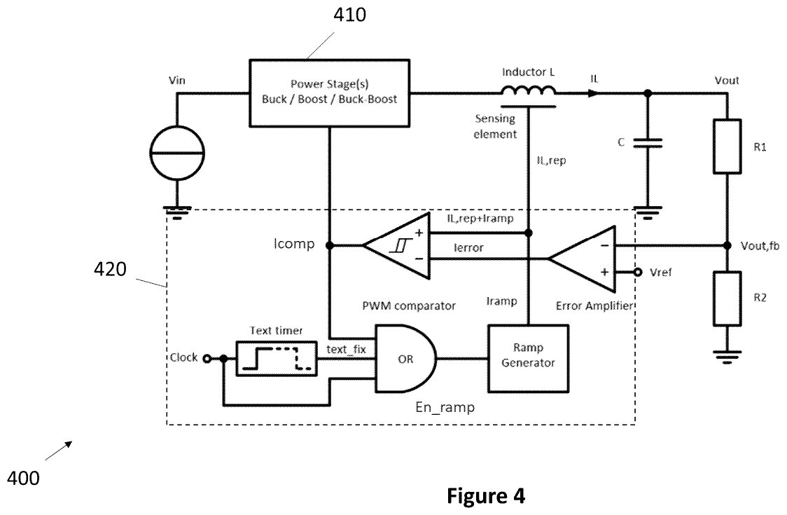

FIG. 4 is a diagram of a power converter for implementing the method of FIG. 3. The power converter 400 includes a power stage 410 coupled to a controller 420. The controller 420 includes a ramp generator, an error amplifier, a comparator, and a logic circuit configured to generate a control signal, (enable signal En_ramp) to control the ramp generator. The comparator may be implemented as a pulse width modulation (PWM) comparator. The ramp generator may be configured to generate a ramp signal having a predefined ramp signal having a predefined slope.

A clock generator is provided for generating a clock signal CLK having a clock on-time, and a timer is provided for generating a timer signal having a timer on time. The timer is also configured to generate a trigger signal (text_fix) that triggers the end of the timer on time. In this implementation, the logic circuit comprises an OR logic gate having a first input for receiving a comparison signal from the comparator, a second input for receiving the trigger signal (text_fix) and a third input for receiving the clock signal.

In operation, an output feedback voltage Vout,fb is fed back to the system using a resistive voltage divider R1 and R2. The error amplifier compares the feedback voltage to a reference voltage Vref to generate an error signal Ierror. The comparator receives the error signal at a first input for receiving and a compensated inductor current signal at a second input. The compensated inductor signal is obtained by adding a sensed inductor current to the ramp signal generated by the ramp generator. The comparator provides a comparison signal (Icomp) based on the comparison.

The comparison signal, also referred to as duty cycle signal, is a logic signal that is either high (logic 1) or low (logic 0). The comparison signal is then used to control the driver driving the power switches of the power stage 410. The comparison signal is also sent to the OR gate for generating the enable signal controlling the ramp generator. The enable signal En_ramp controls the timing of when the ramp signal should be generated during the switching cycle, hence controlling at which point the ramp signal is added to the sensed inductor signal.

When the comparison signal occurs during the timer on-time, the ramp signal is added between the end of the timer signal of a given switching cycle and a peak current event of a subsequent switching cycle directly following the given switching cycle to operate the power converter in the intermediate mode.

When the comparison signal occurs after the timer on-time, the ramp signal is added between the peak current event of the given switching cycle and the peak current event of the subsequent switching cycle directly following the given switching cycle to operate the power converter in the boost mode.

When the comparison signal occurs during the clock on-time, the ramp signal is added between the start of the clock signal and a peak current event of the subsequent switching cycle directly following the given switching cycle to operate the power converter in the buck-boost mode.

The peak current event occurs when the comparison signal assert itself from logic low to logic high.

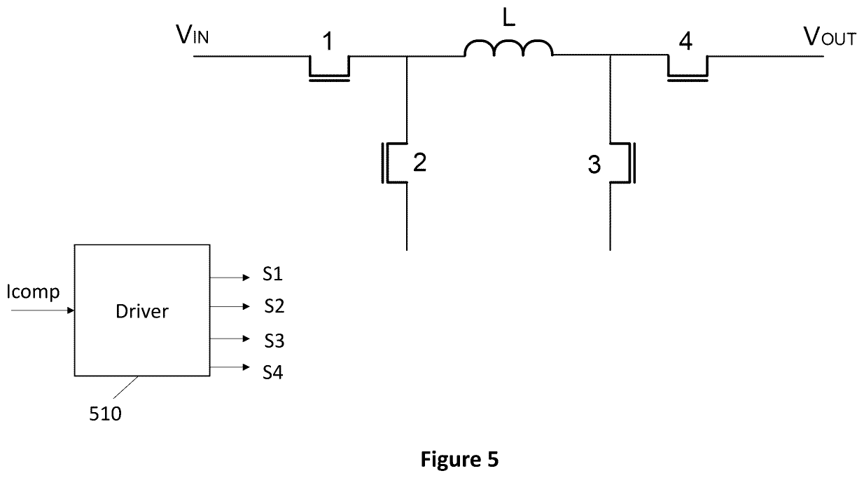

FIG. 5 is a diagram of a power stage for use in the power converter of FIG. 4. The power stage 500 is provided between an input port and an output port. The power stage 500 includes an inductor L, and four power switches. The first power switch (1) is arranged between the input port and a first node of the inductor. The second power switch (2) is arranged between the first node of the inductor and ground. The third power switch (3) is arranged between a second node of the inductor and ground. The fourth power switch (4) is arranged between the output port and the second node of the inductor. A driver 510 is provided to control and a set of power switches. The driver 510 receives the comparison signal Icomp and generates the signals S1-S4 for controlling power switches 1-4.

In the intermediate mode and in the boost mode, the power converter is operated in a first phase with the first and third power switches (1, 3) and a second phase with the first and fourth power switches (1, 4). In this case the peak current event occurs within the switching cycle at a point in time between the first phase and the second phase.

In the Buck Boost mode, the power converter is operated in a first phase with the first and third power switches (1,3), a second phase with the first and fourth power switches (1,4), and a third phase with the second and fourth power switches (2,4). In this case the peak current event occurs within the switching cycle at a point in time between the second phase and the third phase.

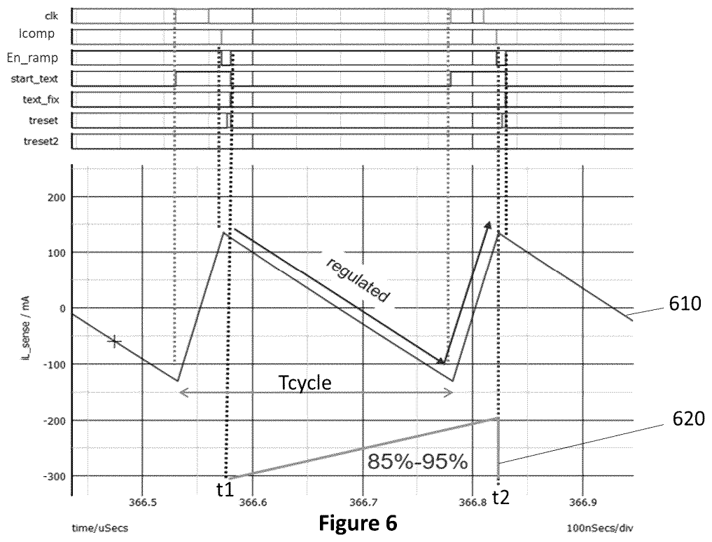

FIG. 6 is a plot illustrating the operation of the power converter of FIG. 4 in the intermediate mode. FIG. 6 shows the waveforms of the sensed inductor current 610 and the ramp signal 620.

When the clk signal triggers, the inductor charge phase is initiated. At the same time, the timer signal is started (start_text). The timer signal has a timer on-time that is longer than the clock on-time of the clock signal and longer than the converter loop-delay. Whenever the comparison signal Icomp triggers after the clock on-time expiration and before the timer on-time expiration, the converter is in the intermediate mode also referred to as Hybrid Boost mode operation.

A switching cycle starts and ends between two consecutive clock signals, with a constant period Tcycle. In this mode, the ramp signal 620 is added between the end of the timer signal at time t1 in the switching cycle (falling edge of start_text) and a peak current of the subsequent switching cycle at time t2 (rising edge of Icomp).

The current measurement is performed until the next comparator signal Icomp trigger. When Icomp triggers at the same time as the timer on-time expires, the regulation is 95% duty cycle. If Icomp triggers earlier than the next timer on-time expiration, the duty cycle adjusts automatically to <95%. As an example, the Hybrid Boost mode operation automatically regulates between 85%-95% duty cycle. Depending on the Vin-to-Vout ratio, the Icomp trigger will be slightly shorter or longer and therefore indicates a shorter or longer inductor on-time.

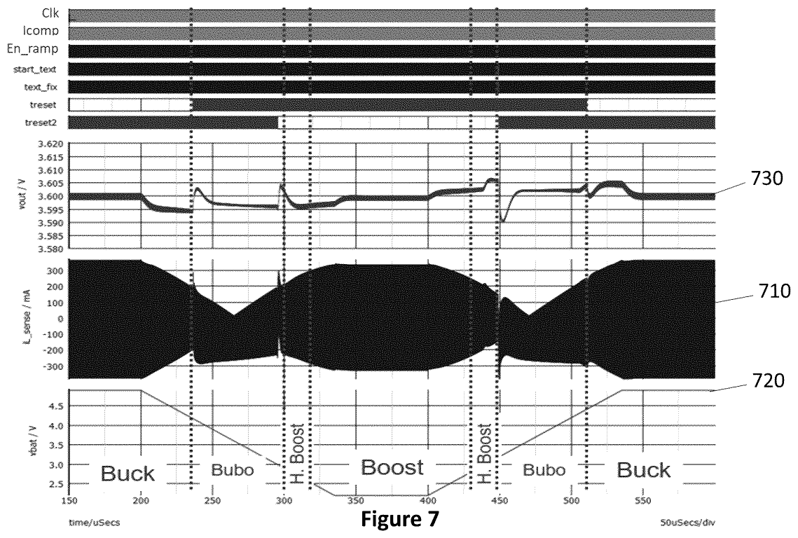

FIG. 7 is a plot illustrating transition between Buck-Boost, Hybrid Boost and Boost modes. FIG. 7 shows the waveforms of the sensed inductor current 710, the input voltage Vbat (=Vin) 720 and the output voltage Vout 730. There are two mode transitions that arise by the addition of the Hybrid Boost mode. The first transition is between the Buck-Boost mode (Bubo) and the Hybrid Boost mode in both directions (A: Bubo—Hybrid Boost; and B: Hybrid Boost—Bubo). The second transition is between the Hybrid Boost mode and the Boost mode in both directions (A: Hybrid Boost—Boost; and B: Boost—Hybrid Boost).

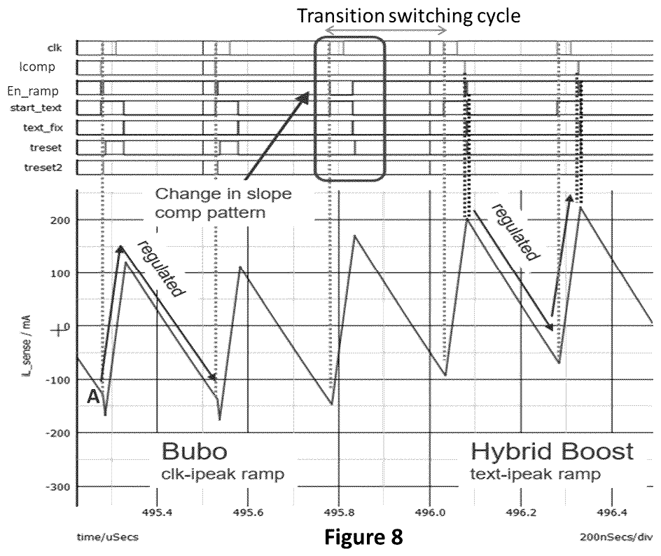

FIG. 8 is a plot showing the transition from Bubo to Hybrid Boost mode. When the converter operates in the buck-boost mode, the controller determines if the comparison signal occurs before the on-time of a clock signal. If the comparison signal Icomp triggers before the clock on time, then the controller maintains operation in the buck-boost mode within a subsequent switching cycle.

If the clock on-time arrives before the comparison signal Icomp triggers, then the controller operates the power converter in the intermediate mode within the subsequent switching cycle. The next inductor charge phase is initiated with the timer signal start_text. The ramp signal is then added as described above with reference to FIG. 6.

The first switching cycle in Bubo mode starts with a peak (local peak) at point A. This local peak A is still present in the second switching cycle but disappears at the start of the third switching cycle which is the transition cycle towards the hybrid boost mode. The power converter stays in the Hybrid Boost mode as long as the comparison signal Icomp triggers after the clock on-time and during the timer on-time.

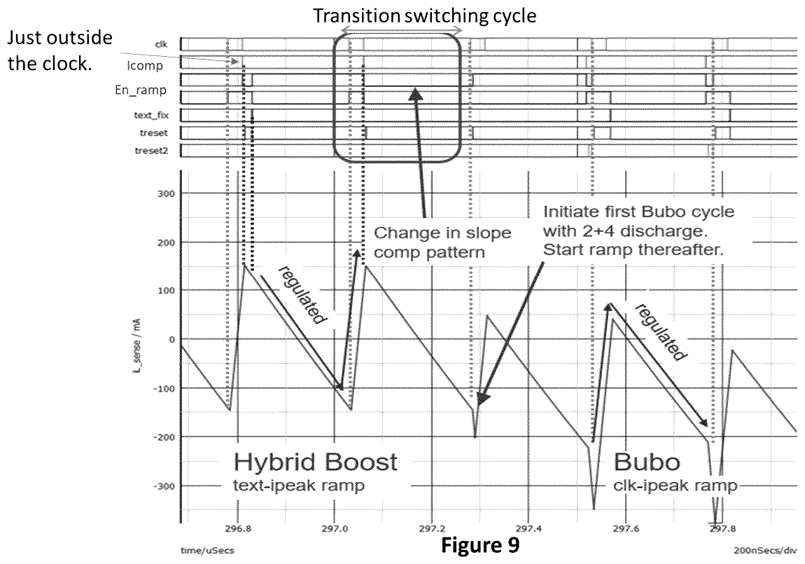

FIG. 9 is a plot showing the transition from Hybrid Boost to Bubo mode. When the converter operates in the intermediate mode (hybrid Boost mode), the controller determines if the comparison signal occurs during or after the clock on-time. If the comparison signal occurs after the clock on-time the controller maintains operation in the intermediate mode within a subsequent switching cycle.

If the comparison signal occurs during the clock on-time, the controller completes the switching cycle and stops adding the ramp signal to the subsequent switching cycle to operate the power converter in the buck-boost mode.

In FIG. 9, for the first switching cycle, Icomp is just outside (after) the clock on-time. In the transition switching cycle Icomp is just inside the clock on-time. At the next clock cycle, the switching cycle starts with short discharge (using power switches 2 and 4) into the first Bubo cycle. The rest of the clk pulse is used to charge (using power switches 1 and 3). Ramp is added with the start of the clock on-time thus measuring inductor current in a first phase with the first and the third power switches enabled, followed by measuring inductor current in a second phase with the first and the fourth power switches enabled. The comparison signal occurs between the second phase and a third phase comprising the second and fourth power switches enabled to finish the mode transition. If the comparison signal Icomp in Bubo mode is before the clock on-time, the power converter maintains in Bubo operation.

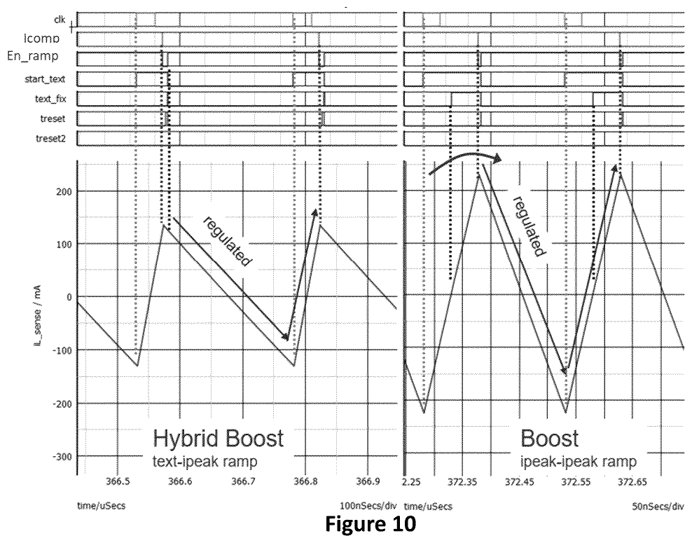

FIG. 10 is a plot showing the transition from Hybrid Boost to Boost mode. When the converter operates in the intermediate mode, the controller identifies the state of the comparison signal Icomp and of the trigger signal text_fix that triggers the end of the timer on time.

If within a given switching cycle, the comparison signal Icomp is in a logic high state while the trigger signal is in a logic low state, then the controller maintains operation in the intermediate mode.

If within a given switching cycle the comparison signal and the trigger signal are both in a logic high state at a same time, then the controller operates the power converter in boost mode within the subsequent switching cycle.

The ramp signal is synchronized for peak-to-peak regulation (meaning inductor “on” time is long and aliasing-effect is avoided) to finalize the transition into Boost mode. The regulation is back to always ~95% duty cycle.

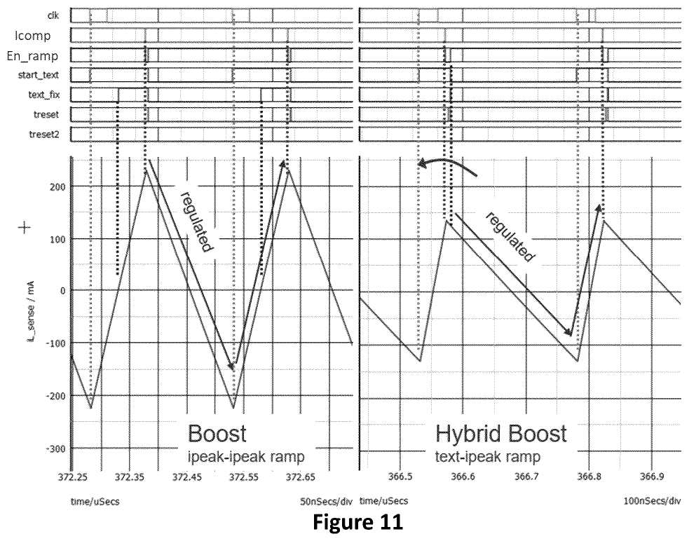

FIG. 11 is a plot showing the transition from Boost to Hybrid Boost mode. When the converter operates in the boost mode, the controller identifies the state of the comparison signal and of a trigger signal (text_fix) that triggers the end of the timer on time.

If within a given switching cycle the comparison signal and the trigger signal are both in a logic high state at a same time, then operation is maintained in the boost mode.

If within a given switching cycle the comparison signal is in a logic high state while the trigger signal is in a logic low state, then the power converter operates in intermediate mode within the subsequent switching cycle.

The ramp signal is synchronized to text-to-peak regulation (meaning inductor “on” time is short and aliasing-effect would occur) to finalize the transition into Hybrid Boost mode. The regulation is back to automatic 85%-95% duty cycle regulation from text-to-peak that stabilizes the loop.

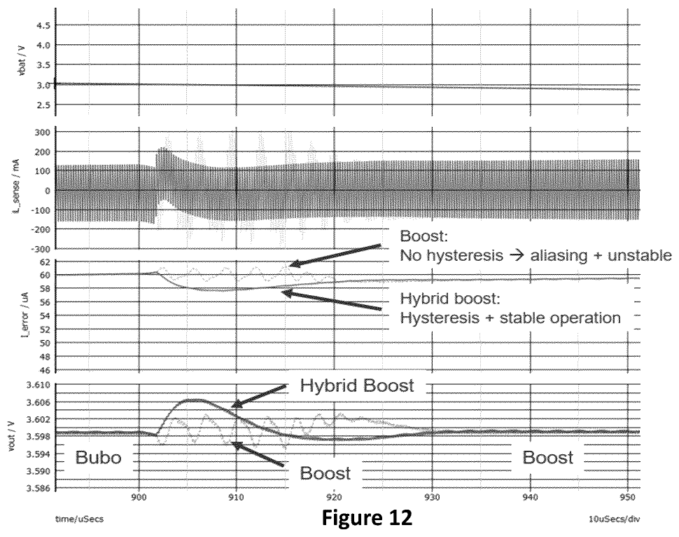

FIG. 12 is a simulation comparing transition from Buck-Boost mode to Boost mode using the method of FIG. 3 compared with the method described in FIG. 2. FIG. 12 shows the input voltage Vbat, the sensed inductor current, the error signal and the output voltage. The waveforms corresponding to the method of the present disclosure are shown in plain lines and the waveforms corresponding to the method described in FIG. 2 are shown in dash lines.

The method of FIG. 2 shows instability in boost operation when transitioning from Bubo to Boost mode. If the input voltage stays in the range where the Boost mode is unstable, operation of the power converter will be unstable and oscillate.

For the method of the disclosure the transition from Bubo to Hybrid Boost to Boost mode is associated with a drop in the error current that translates into lower than 95% duty cycle when entering Hybrid Boost mode from Bubo mode. This duty cycle is then automatically adjusted until it reaches 95% again to do another transition into Boost mode operation.

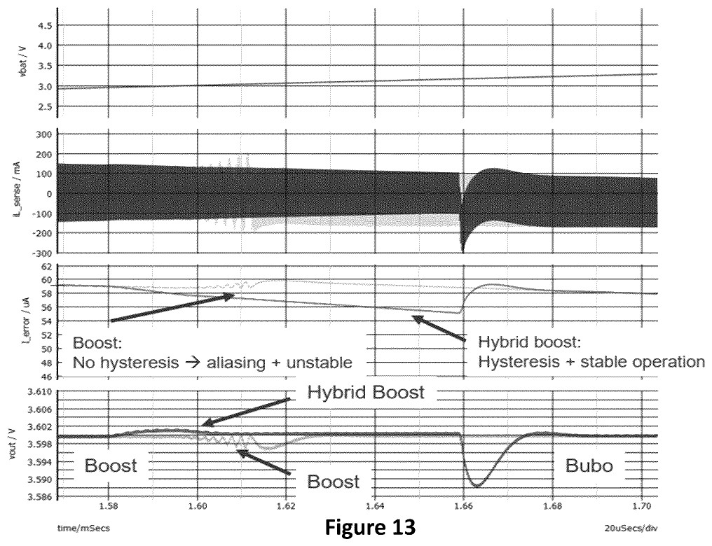

FIG. 13 is a simulation comparing transition from Boost mode to Buck-Boost mode using the method of FIG. 3 compared with the method described in FIG. 2. FIG. 13 shows the input voltage Vbat, the sensed inductor current, the error signal and the output voltage. The waveforms corresponding to the method of the present disclosure are shown in plain lines and the waveforms corresponding to the method of FIG. 2 are shown in dash lines.

The method described in FIG. 2 shows instability in boost operation when transitioning from Boost to Bubo mode. If the input voltage stays in the range where the Boost mode is unstable, operation of the power converter will be unstable and oscillate.

For the method of the disclosure, the transition from Boost to Hybrid Boost to Bubo mode is associated with a drop in the error current that translates into lower than 95% duty cycle when entering Hybrid Boost mode. This duty cycle is then automatically adjusted until it reaches 85% again to do another transition into Bubo mode operation.

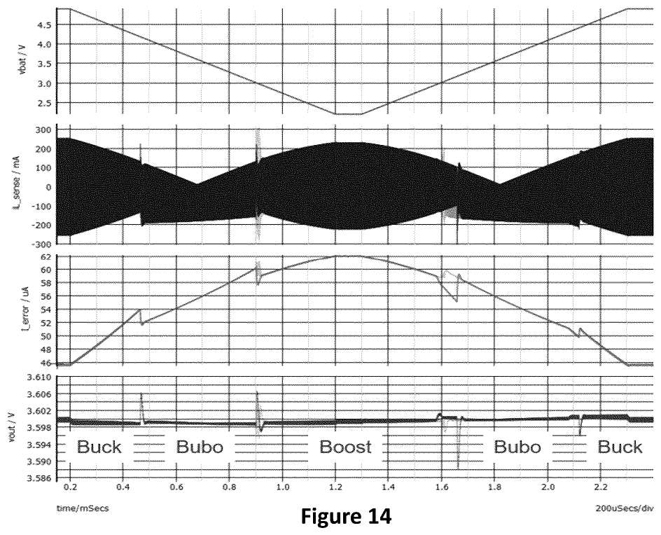

FIG. 14 is a simulation comparing transition across all modes using the method of FIG. 3 compared with the method described in FIG. 2. FIG. 14 shows the input voltage Vbat, the sensed inductor current, the error signal and the output voltage. The waveforms corresponding to the method of the present disclosure are shown in plain lines and the waveforms corresponding to the method described in FIG. 2 are shown in dash lines.

The method of FIG. 2 shows instability in boost operation whenever transitioning from Boost to Bubo mode or vice versa. If the input voltage stays in the range where the Boost mode is unstable, the operation of the power converter will be unstable and oscillate.

For the method of the disclosure, the transition from Boost to Hybrid Boost to Bubo mode or vice versa remains stable. In addition, the proposed method can be used to provide high converter efficiency in Bubo mode due to smaller inductor current ripple; achieved by long intermediate phase (using power switches 1 and 4), where Vin is directly connected to Vout with respect to the switching cycle. There is also no minimum on-time restrictions in Bubo and Boost modes. There is also no need for pedestal/feed-forward currents to correct for discontinuous Ierror signal at mode boundaries.

A skilled person will appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A method of operating a power converter in a plurality of modes that include a buck-boost mode, a boost mode, and an intermediate mode between the buck-boost mode and the boost mode; the method comprising:
starting a clock signal having a clock on-time, and wherein the clock on-time defines the start of a given switching cycle;
starting a timer for generating a timer signal at the beginning of the given switching cycle, wherein the timer signal has a timer on-time;
sensing a current through an inductor of the power converter to obtain a sensed inductor current;
adding a ramp signal to the sensed inductor current to obtain a compensated inductor current signal;
comparing the compensated inductor current signal with an error signal to obtain a comparison signal;
determining a position of the comparison signal within the given switching cycle by identifying if the comparison signal of the sensed inductor current occurs during the timer on-time, or after the timer on-time, or during the clock on-time; and
wherein adding the ramp signal to the sensed inductor current is based on the position of the comparison signal; and
operating the power converter in the buck-boost mode, the boost mode, or the intermediate mode using the comparison signal.

2. The method as claimed in claim 1, wherein when the comparison signal occurs during the timer on-time, adding the ramp signal between the end of the timer signal of the given switching cycle and a peak current event of a subsequent switching cycle directly following the given switching cycle to operate the power converter in the intermediate mode; and
when the comparison signal occurs after the timer on-time, adding the ramp signal between the peak current event of the given switching cycle and the peak current event of the subsequent switching cycle directly following the given switching cycle to operate the power converter in the boost mode; and
when the comparison signal occurs during the clock on-time, adding the ramp signal between the start of the clock signal and a peak current event of the subsequent switching cycle directly following the given switching cycle to operate the power converter in the buck-boost mode.

3. The method as claimed in claim 2, wherein the peak current event occurs when the comparison signal assert itself from logic low to logic high.

4. The method as claimed in claim 1, wherein when the converter operates in the buck-boost mode,
determining if the comparison signal occurs before the on-time of a clock signal;
maintaining operation in the buck-boost mode within a subsequent switching cycle, if the comparison signal triggers before the clock on time; and
operating the power converter in the intermediate mode within the subsequent switching cycle if the clock on time arrives before the comparison signal triggers.

5. The method as claimed in claim 1, wherein when the converter operates in the intermediate mode,
determining if the comparison signal occurs during or after the clock on-time; and
maintaining operation in the intermediate mode within a subsequent switching cycle, if the comparison signal occurs after the clock on-time; and
if the comparison signal occurs during the clock on-time, complete the switching cycle and stop adding the ramp signal to the subsequent switching cycle to operate the power converter in the buck-boost mode.

6. The method as claimed in claim 1, wherein when the converter operates in the intermediate mode,
identifying the state of the comparison signal and of a trigger signal that triggers the end of the timer on time; and
maintaining operation in the intermediate mode if within a given switching cycle the comparison signal is in a logic high state while the trigger signal is in a logic low state; and
operating the power converter in boost mode within the subsequent switching cycle if within a given switching cycle the comparison signal and the trigger signal are both in a logic high state at a same time.

7. The method as claimed in claim 1, wherein when the converter operates in the boost mode,
identifying the state of the comparison signal and of a trigger signal that triggers the end of the timer on time; and
maintaining operation in the boost mode if within a given switching cycle the comparison signal and the trigger signal are both in a logic high state at a same time; and
operating the power converter in intermediate mode within the subsequent switching cycle if within a given switching cycle the comparison signal is in a logic high state while the trigger signal is in a logic low state.

8. The method as claimed in claim 2, wherein the power converter comprises
a first power switch arranged between an input port and a first node of the inductor;
a second power switch arranged between the first node of the inductor and ground;
a third power switch arranged between a second node of the inductor and ground; and
a fourth power switch arranged between an output port and the second node of the inductor.

9. The method as claimed in claim 8, wherein in the intermediate mode and in the boost mode, the power converter is operated in a first phase with the first and third power switches and a second phase with the first and fourth power switches, and wherein the peak current event occurs within the switching cycle at a point in time between the first phase and the second phase.

10. The method as claimed in claim 8, wherein in the buck-boost mode, the power converter is operated in a first phase with the first and third power switches, a second phase with the first and fourth power switches, and a third phase with the second and fourth power switches, and wherein the peak current event occurs within the switching cycle at a point in time between the second phase and the third phase.

11. A controller for controlling a power converter, wherein the controller is configured to operate the power converter in a buck-boost mode or an intermediate mode or a boost mode; wherein the controller is configured to perform the method of claim 1.

12. The controller as claimed in claim 11, comprising
a ramp generator for generating the ramp signal;
an error amplifier configured to generate the error signal;
a comparator having a first input for receiving the error signal and a second input for receiving the compensated inductor current signal;
a timer for generating the timer signal;
a clock generator for generating the clock signal;
a logic circuit configured to generate a control signal to control the ramp generator.

13. The controller as claimed in claim 12, wherein the control signal is configured to control a timing of when the ramp signal should be generated during the switching cycle.

14. The controller as claimed in claim 12, wherein the logic circuit comprises an OR logic gate having a first input for receiving the comparison signal, a second input for receiving a trigger signal that triggers the end of the timer on time; and a third input for receiving the clock signal.

15. A power converter comprising a controller as claimed in claim 11, coupled to a power stage provided between an input port and an output port.

16. The power converter as claimed in claim 15, wherein the power stage comprises
an inductor
a first power switch arranged between the input port and a first node of the inductor;
a second power switch arranged between the first node of the inductor and ground;
a third power switch arranged between a second node of the inductor and ground; and
a fourth power switch arranged between the output port and the second node of the inductor.
